(19) United States
(12) Patent Application Publication
(10) Pub. No.: US 2021/0337716 A1
(43) Pub. Date: Nov. 4, 2021

(54) GRASS MAINTENANCE SYSTEM

(71) Applicant: TECHTRONIC CORDLESS GP, Anderson, SC (US)

(72) Inventors: Hei Man Raymond Lee, Kwai Chung (CN); Ngai Cheung, Kwai Chung (CN); Dohoon Kim, Kwai Chung (CN); Denis Gaston Fauteux, Kwai Chung (CN); Hal Llan, Guangdong (CN)

(21) Appl. No.: 17/273,644

(22) PCT Filed: Sep. 28, 2018
(86) PCT No.: PCT/CN2018/108368

§ 371 Date: Mar. 4, 2021

(51) Int. Cl. A01B 69/04; A01D 34/00; A01G 20/43; A01G 25/16; A01C 21/00; A01G 13/02; A01G 25/09; B60W 60/00

(52) U.S. Cl. CPC A01B 69/008; A01D 34/008; A01G 20/43; A01G 25/167; A01D 2101/00; A01G 13/0287; A01G 25/09; B60W 60/0025; A01C 21/007

(57) ABSTRACT

A system and a method for a grass maintenance comprising an autonomous vehicle (100) arranged to operate autonomously to manipulate a grass surface, wherein the vehicle (100) includes one or more environmental sensors (208) arranged to detect environmental conditions associated with the grass surface; and one or more grass manipulation modules (210) arranged to manipulate the grass surface.

### TECHNICAL FIELD

The present invention relates to a grass maintenance system, and particularly, although not exclusively, an autonomous grass maintenance system arranged to perform maintenance work on a lawn autonomously.

### BACKGROUND

Lawn maintenance is a tedious chore that requires a significant amount of effort on the part of a gardener. A well-kept lawn, although rewarding for its owner, requires watering, mowing, fertilizing, seeding, raking and regular care.

Technology has made lawn maintenance easier in recent time with the development of mechanical or powered tools such as lawn mowers which allow a gardener to mow the grass relatively quickly and with a reduced effort. Automated irrigation systems are also helpful to keep a lawn well watered during the drier seasons.

Despite the use of technologies in tools to reduce the workload of a gardener, much effort is nonetheless required on the part of the gardener. This is particularly the case during the warmer or drier months when the grass on a lawn may grow significantly within a few days or that the lawn would dry out more quickly. In turn, the amount of maintained required may increase significantly for the gardener to ensure that the lawn is well maintained throughout the year.

### SUMMARY OF THE INVENTION

In accordance with a first aspect of the present invention, there is provided an autonomous vehicle arranged to operate autonomously to manipulate a grass surface, wherein the vehicle includes
one or more environmental sensors arranged to detect environmental conditions associated with the grass surface; and
one or more grass manipulation modules arranged to manipulate the grass surface.

In an embodiment of the first aspect, the autonomous vehicle further includes a control module arranged to obtain environmental conditions from the one or more environmental sensors for controlling the one or more grass manipulation modules to manipulate the grass surface.

In an embodiment of the first aspect, the control module includes a navigational module arranged to navigate the autonomous vehicle during its operation.

In an embodiment of the first aspect, the navigational module includes a positioning system arranged to determine a location of the autonomous vehicle during its operation.

In an embodiment of the first aspect, the positioning system uses a wireless signal to determine the location of the autonomous vehicle.

In an embodiment of the first aspect, the wireless signal is an Ultra Wideband signal.

In an embodiment of the first aspect, the environmental conditions associated includes one or more of temperature, humidity, wind intensity, wind direction, air quality, VOC levels, rain intensity.

In an embodiment of the first aspect, the environmental conditions further include substrate conditions.

In an embodiment of the first aspect, the substrate conditions include soil pH, soil chemistry, soil moisture or any one or combination thereof.

In an embodiment of the first aspect, the one or more grass manipulation modules is arranged to perform one or more of the following manipulation steps, including, mowing, cutting, trimming, edge trimming, raking, mulching.

In an embodiment of the first aspect, the one or more grass manipulation modules are further arranged to perform one or more of the following manipulation steps, including watering, fertilizing, seeding.

In an embodiment of the first aspect, the one or more grass manipulation modules include a height adjustment system arranged to adjust the height of a cutting blade so as to mow, cut or trim the grass to a certain length.

In an embodiment of the first aspect, the one or more environmental sensors are arranged to detect environmental condition about the grass surface, and to record the detected environmental condition detected with an associated position.

In an embodiment of the first aspect, the control module is arranged to determine an operation plan as based on the environmental conditions detected by the one or more environmental sensors.

In an embodiment of the first aspect, the operation plan is performed by the control module to manipulate the grass surface.

In an embodiment of the first aspect, the control module is arranged to communicate with an external computing device.

In an embodiment of the first aspect, the control module is arranged to exchange grass related data with a lawn maintenance platform.

In an embodiment of the first aspect, the one or more grass manipulation modules may be removably installed on the vehicle.

In an embodiment of the first aspect, the one or more grass manipulation modules may be removably installed autonomously.

In an embodiment of the first aspect, the one or more grass manipulation modules may be removed or installed when the vehicle is in a base station.

In an embodiment of the first aspect, the navigation module uses an odometry system to measure the distance travelled by the vehicle.

In an embodiment of the first aspect, the navigation module further uses a inertia measurement unit (IMU) to measure the direction travelled by the vehicle.

In an embodiment of the first aspect, the distance and direction travelled by the vehicle as measured by the odometry system and IMU are combined and used by the position system to assist the position system to determine the position.

### BRIEF DESCRIPTION OF THE DRAWINGS

Embodiments of the present invention will now be described, by way of example, with reference to the accompanying drawings in which:

FIG. 1 is a schematic diagram with one embodiment of a grass maintenance system in the form of an autonomous vehicle;

FIG. 2 is a block diagram of an embodiment of a grass maintenance system in accordance with one embodiment of the present invention;

FIG. 3 is a block diagram of a navigation module for use in an example embodiment of the grass maintenance system;

FIG. 4 is a block diagram showing the environmental sensors for use in one example embodiment of the grass maintenance system; and

FIG. 5 is a block diagram showing the grass manipulation modules in one example embodiment of the grass maintenance system.

### DETAILED DESCRIPTION OF THE PREFERRED EMBODIMENT

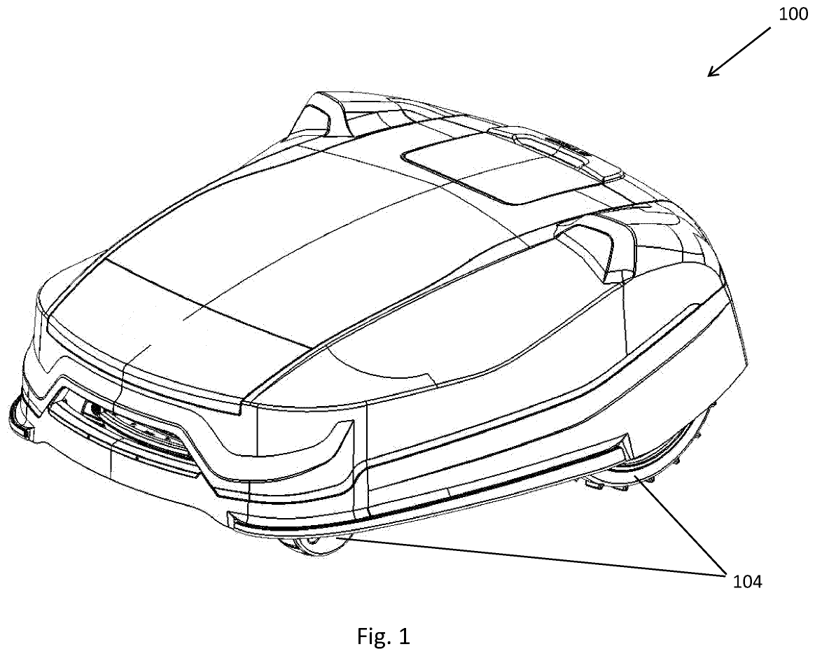

With reference to FIG. 1, there is illustrated an example embodiment of a grass maintenance system comprising: an autonomous vehicle 100 arranged to operate autonomously to manipulate a grass surface, wherein the vehicle 100 includes:
one or more environmental sensors 208 arranged to detect environmental conditions associated with the grass surface; and
one or more grass manipulation modules 210 arranged to manipulate the grass surface.

In this embodiment, the grass maintenance system is implemented in the form of an autonomous vehicle 100 which is arranged to navigate and propel itself autonomously about an operation area. This operation area may be, for example, a patch of lawn or grassed area suitable for the performance of maintenance procedures so as to maintain the lawn or grass. In turn, the grass or lawn to which the system is operating on would be maintained with minimal or no human interference. This maintenance may include, without limitations:
the mowing of the grass;
the trimming of the grass around edges and objects;
the watering and fertilization of the grass and its substrate;
the seeding of grass seeds or seedlings;
the mulching of any grass debris;
the raking of the grass for removal of dead or loose grass debris;
the testing and analysis of the underlying substrate (soil) or grass conditions;
the collection, removal or mulching of any weeds or debris, including garden related debris such as fallen leaves, dead vegetation or animal faecal matter;
the collection of information and/or analysis of environmental conditions associated with the condition, growth rate or health of the grass.

As shown in this example, the autonomous vehicle 100 includes a propulsion system which includes a plurality of wheels 104 driven by a motor unit. Preferably, the autonomous vehicle 100 is electrically powered, although other forms of propulsion, such as by internal combustion engines are also possible and readily adaptable. Hybrid power trains such as those that combine internal combustion engines with electric motors are also a possible combination to power the autonomous vehicle 100. The propulsion system may also be controlled by a controller or control module which would operate with a navigation module to identify the vehicles location relative to its surroundings and thus allowing the controller to determine a direction of travel which will in turn be issued as a command to the propulsion unit so as to propel the autonomous vehicle to a desired position.

The controller may also be in communication with one or more grass manipulation modules and one or more environmental sensor modules. The one or more grass manipulation modules are arranged to manipulate the grass on the operating surface. This manipulation may include the physical manipulation of or interaction with the grass or the lawn surface such as by cutting or mowing the grass, the mulching of grass debris, the raking of the lawn to remove dead or loose grass, weeds or other vegetation debris, the trimming of edges or infant grass sprouts, or the watering, fertilizing, seeding of the grass surface.

In turn, the autonomous vehicle 100 is arranged to operate about a lawn area and perform the grass manipulation actions to maintain the lawn. Effectively, these actions may include cutting, raking, fertilizing, watering, trimming or seeding the lawn autonomously. This process may be initiated by a user who would deploy the grass maintenance system onto a working area such as a lawn or garden, and when the system is appropriately set up, the autonomous vehicle 100 would navigate and direct itself throughout the operating area or areas and proceed to manipulate the grass within the operating area or areas.

In order to perform all of these grass manipulation actions, the autonomous vehicle 100 may be specifically implemented to have one or more of these manipulation modules thereon with each module being controlled by the controller or the control module. The controller is preferably in the form of an electronic or computer based processor arranged to generate and issue commands to actuate each of the manipulation modules when it is desirable to do so. As each grass manipulation module may have its own function, in some example embodiments, it would not be desirable to have all of the grass manipulation modules to be implemented on the autonomous vehicle 100 at one time. Thus in a preferred embodiment, certain modules, such as the grass cutting module arranged to mow the grass, and the mulching module arranged to mulch the grass debris may be installed on the vehicle permanently whilst other modules, such as the rake module or fertilizer module may be partially or entirely implemented to be installed or removed on the autonomous vehicle when necessary. This is advantageous in that the overall size and mass of the autonomous vehicle is reduced, allowing the modules which will be used to be installed when needed. This installation may also be performed manually by a user, although in a preferred example embodiment, the installation process can be performed autonomously also.

Thus in these examples where grass manipulation modules may be installed or removed, a user may perform this installation and removal as necessary. However, in a preferred embodiment, the autonomous vehicle may be able to perform this installation and removal by itself when the desired grass manipulation module is required for use. This may be performed by use of a base station, or may also be referred to as a docking station, which would be part of the grass manipulation system that could house the autonomous vehicle when it is not in use. The base station may be arranged to provide several functions to the autonomous vehicle such as electrical charging capabilities, the downloading and collection of data, internet capabilities, cleaning functions, refill or emptying functions, or the exchange of grass manipulation modules, such as by removal of the mower blades and replacing it with a power rake module.

In this embodiment, the grass maintenance system is also arranged to include one or more environmental sensors which are arranged to measure, detect and analyse environmental conditions that can affect or otherwise be associated with the health of the grass. These sensors may include, without limitations:
chemical sensor to measure the soil composition;
soil moisture sensor;
soil pH value sensor;
environmental temperature;
environmental humidity;
altitude sensor;
wind direction;
sunlight sensor;
colour sensor;
weather conditions, including altimeter, barometric measurements or rain sensors or Internet accessible weather information for a specific geographical location.

In this embodiment, the environmental sensors may be implemented on any part of the grass maintenance system, including the base station, the autonomous vehicle, propulsion unit or one or more of the grass manipulation modules. These sensors are arranged to communicate with the controller so as to detect the environmental conditions that may affect the growth and health of the grass. Once these sensors are able to obtain a reading for analysis, the information is then transmitted back to the controller for processing, and in turn, an appropriate action may then be determined and performed by the grass maintenance system by instructing the autonomous vehicle 100 to undertake certain grass manipulation actions. As an example, the following actions may be taken by the autonomous vehicle 100:
water the grass at one or more locations if moisture levels are below a predetermined threshold;
add fertilizer to the soil at one or more locations if soil analysis indicates fertilization is necessary;
distribution of seeds to a location where there is detected minimal grass coverage and suitable soil conditions;
performing a raking action with the power rake if a significant amount of dead grass debris is detected;
mowing of grass where grass thickness is detected to exceed to predetermined threshold or as determined based on the date of the last mowing action.

Preferably, the controller may be able to determine additional actions based on one or more collective readings from the environmental sensors, either immediately or over a period of time to determine a grass maintenance procedure that can be performed by the grass maintenance system. Additionally, the controller may also collect information on usage, motor load, power consumption of the vehicle and various environmental information and transmit this information to a cloud base service so as to obtain additional grass maintenance procedures that may be suggested by users or a computerized data mining tool after collective analysis of information from multiple systems that may be in place within a geographical area or globally.

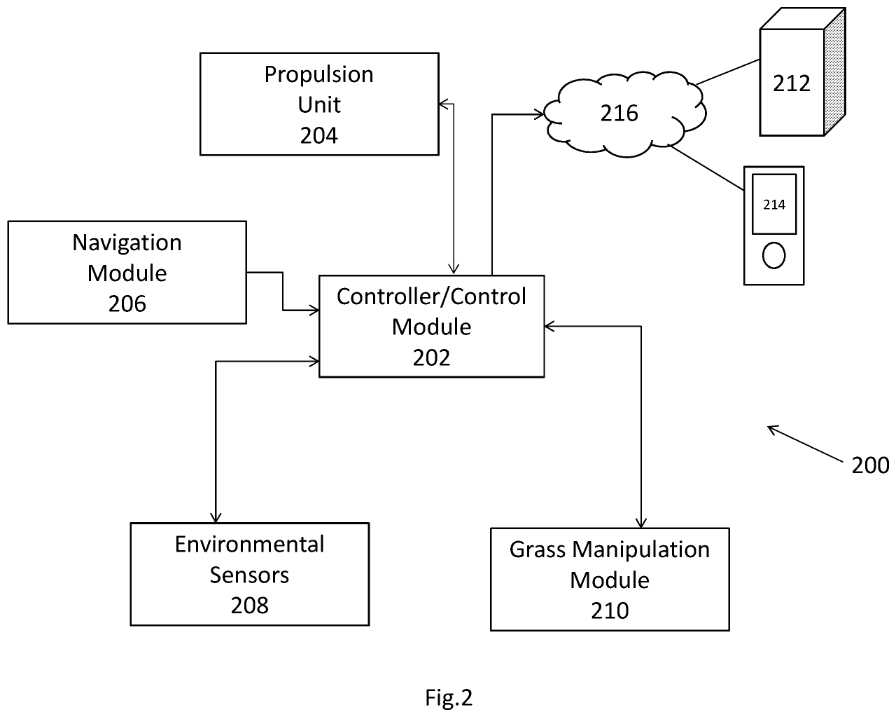

With reference to FIG. 2, there is illustrated a block diagram of an example an autonomous vehicle 100 arranged to operate as a grass maintenance system 200. The diagram shows the different components of the system 200 which operate together as an embodiment of the grass maintenance system 200.

As shown, the autonomous vehicle 100 has a control module or controller 202 which is arranged to control the overall operation of the system 200, a propulsion unit 204 which is arranged to provide propulsion to the autonomous vehicle 100 when in operation, a navigation module 206 arranged to navigate and track the location of the vehicle 100 in preparation for operation or when it is in operation, environmental sensors 208 arranged to detect environmental conditions associated with the lawn or grassed areas and one or more grass manipulation modules 210 which are modules arranged to manipulate with the grass within the operational areas.

As shown in FIG. 2, the grass maintenance system 200, as in the form of an autonomous vehicle 100, includes these various modules to perform an autonomous action on a grass surface or lawn so as to maintain a lawn autonomously with minimal or little human interference. As a general overview, the grass maintenance system 200 can mow, trim, rake or mulch the grass to a suitable length so as to maintain the clean and freshly cut appearance of a lawn. However, as lawn maintenance includes other tasks in addition to mowing, the system 200 may also be arranged to have additional grass manipulation modules 210 which can perform additional tasks, such as watering, seeding, and fertilizing of the lawn. Accordingly, the grass maintenance system 200 is arranged to maintain a healthy, clean and kept lawn with minimal or little human interference as it is able to autonomously navigate about the grassed areas or lawn and upon analysis of the grass or soil condition or environmental conditions and choose to perform a specific task on the grass surface.

In this embodiment, the grass maintenance system 200's controller, control module or control unit 202 is arranged to communicate with the propulsion unit 204, navigation module 206, environmental sensors 208, and grass manipulation modules 210 so as to receive data from each of these modules. In turn, the control unit 202 may include a computer processor or computation unit to process this data along with user commands or data obtained from an external source (e.g. cloud service) to determine a set of commands to maintain the grass surface. The control unit 202 may then issue these determined commands to each of these modules so as to operate the maintenance system 200. As an example, the control unit 202 may determine that the lawn requires mowing, and proceeds to navigate the autonomous vehicle 100 about the operating area whilst operating its mowing module (grass mowing blades) and navigating the vehicle 100 about the lawn with respect to a predetermined pattern, such as, for example, a row by row cutting pattern following a flood-fill method to cover the lawn area as well as navigating around objects and boundaries of the lawn area.

In another example, whilst the vehicle 100 is moving about the operating area, the control unit 202 may detect, via its environmental sensors 208, that a particular part of the lawn is of a low moisture level and/or requires fertilizers. In turn, a sensor arranged to detect soil moisture and soil condition (e.g. pH) would return its readings to the control unit 202 that would process these environmental information to determine that this part of the lawn requires watering or the distribution of fertilizers. The control unit 202 may then direct the vehicle 100 to navigate to this area of the lawn and activate its watering module and fertilizer distribution module so as to supply water and fertilizer to this part of the lawn, whilst recording that this part of the lawn has been watered and fertilized at a particular time so as to allow the control unit 202 to determine the optimal time to revisit this part of the lawn for further manipulation.

The control unit 202 may also be arranged to have a communication gateway 216 arranged to allow the system to communicate with other electronic devices 214. Where the system 200 has a base station 212 to which the autonomous vehicle 100 can dock to for recharging, manipulation module exchange or the cleaning, refilling or emptying of consumables or debris, the communication gateway 216 may be arranged to exchange information with another communication gateway 216 on the base station 212. In this example, the base station 212 may be a hub in which data can be routed from the autonomous vehicle 100 via the base station 212 and onto an intranet or wider area network for connection to other computing devices or cloud based services. Although the control unit 200's communication gateway 216 may also be implemented to communicate with any electronic device 214 via any communication protocol including WiFi, Bluetooth, Cellular networks, etc, communicating with the base station 212 in the first instance may be more advantageous in that the communication gateway 216 on the autonomous vehicle 100 may be more simple and thus be more energy efficient.

By implementing telecommunication functionalities on to the system 200, the system 200 is able to share and communicate data with other external computing devices. This data may include environmental sensor data as well as operation logs, alerts or faults. This exchange of data with external computing devices, such as cloud servers, smartphones or Internet of Things (IoT) devices will permit the exchange of information so as to enhance the usage and operation of the grass maintenance system 200. As an example, a grass maintenance system 200 operating in a user's home may access grass data and soil data common to the location of the user's home as well as weather data. In turn, as based on the characteristics of the grass, soil type and weather, the system 200 is able to determine an optimal maintenance program to maintain the grass in its peak condition. Furthermore, it may also prompt the user, or directly access by itself, an online store of consumables which may be needed to execute these lawn maintenance programs, including the purchase of seeds or fertilizers.

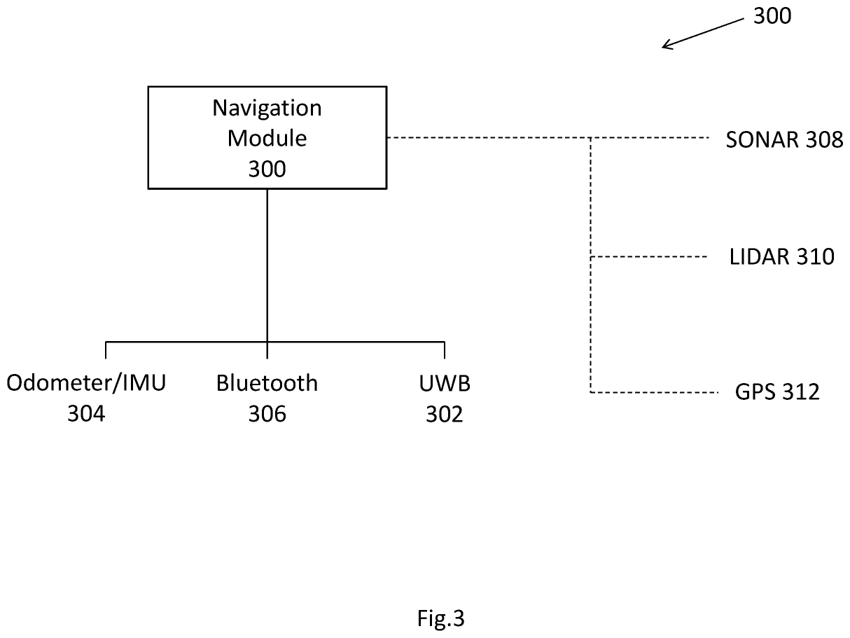

With reference to FIG. 3, there is provided a block diagram to illustrate an example embodiment of a navigation module 300 arranged to provide a navigation function to the autonomous vehicle 100 of the system. In this example embodiment, the navigation module 300 is arranged to communicate with the controller 202 of the autonomous vehicle 100 so as to allow the controller 202 to know its current location and to operate the propulsion unit 204 so as to drive the vehicle 100 to a suitable location for performing grass manipulation tasks.

As shown in FIG. 3, the navigation module 300 provides for at least two functions. The first of these functions is to identify the location of the autonomous vehicle 100, whilst the second is to identify any factors or obstacles that should be considered so as to allow the autonomous vehicle 100 to be moved to a specific location within the operation area. Preferably, to provide these functions, the navigation module 300 may be implemented to use one or more navigation systems or methods to determine a position of the vehicle 100 so as to navigate the vehicle 100 relative to its surroundings. These navigation system and methods include, without limitation:
Global Position System (GPS) or GLONASS or BeiDou or QZSS or Galileo 312 for positioning;
Bluetooth Beacon positioning system 306;
Ultra Wideband (UWB) positioning system 302;
Ultrasound or Sonar systems 308 for detecting and getting around any nearby obstacles;
LIDAR systems 310 for scanning a surrounding area of the vehicle 100;
Odometry and IMU systems 304;
Object recognition systems.

These navigation systems or methods may be implemented within the navigation module 300 and is arranged to respond to commands from the controller 202 to either determine, or to assist the controller 202 to determine one or more suitable methods of navigating the autonomous vehicle 100. These suitable methods may include the determination of the location of the autonomous vehicle 100, followed by determine and executing a plan of movement of the autonomous vehicle 100 about the operating area, such as, without limitation by use of various computerized pathing or path determining methods.

Preferably, the navigation module 300 may, in one example, use Ultra-Wideband (UWB) position systems 302 to assist with locating the vehicle 100 in a specific area. UWB systems 302 uses various “anchors” which are stations that continuously communicate with a tag that is on the vehicle 100 (or vice versa), and by determining the time of flight between each communication, can determine the distance of the vehicle 100 from the anchors. Depending on any mapping information that may previously been made known to the navigation module 300 of the vehicle 100, such as a boundary walk procedure which helps the navigation module 300 to determine a virtual map within its memory of its operating area, the anchors may be able to provide a position of the vehicle 100 relative to each anchor, and by overlapping this information into the virtual map, the navigation module 300 may be able to determine its position within the operation area.

In order to enhance the accuracy of the autonomous vehicle 100 during its start-up and operation phase, an odometery unit and an Inertial Measurement Unit (IMU) 304 may also be used to assist with navigating the vehicle 100. The odometery unit 304 may be able to determine the distance travelled by measuring the revolutions of one or more of the wheels 104 of the vehicle 100. The IMU 304 may also be able to measure the direction and acceleration, angle of movement of the autonomous vehicle 100, thus providing a rough idea as to where the vehicle 100 would be after it has travelled for some time after its departure from an origin. This information may also be used in conjunction with the virtual map and/or UWB signals to assist in determining the vehicles position. Other navigational tools 300, such as GPS 312, Bluetooth 306, iBeacon etc, may also be combined in various combinations so as to assist in locating the position of the vehicle 100 within the operation area.

In preferred examples, as the location of the autonomous vehicle 100 is known at all times during operation, the controller 202 is able to operate any specific grass manipulation module as required based on the present location of the autonomous vehicle 100 and any manipulation plan that has been determined and executed. As an example, if the controller 202 has determined that the grass is to be mowed for a certain part of the operation area, the controller 202 and the navigation module 300 may communicate and operate together to direct the vehicle 100 to the operation area. Once in the correct operation area, the controller 202 will determine an operation plan to mow the grass in this area. Such plans may include, for example, a linear pattern of moving about the operation area so as to permit the cutting of the grass in the area in a linear pattern, and around obstacles. Once the operation plan is to be executed, the navigation module 300 will identify obstacles within the operation area, the location of the autonomous vehicle 100 and assist in the determination of a direction of movement so as to fulfil the movement of the vehicle 100 in accordance with the operation plan. The controller 202, when executing the operation plan, may then operate the necessary grass manipulation module, such as the grass cutting blades, to mow the lawn in the operation area.

As described above, the navigation module 300 may also be arranged to be able to generate a virtual model of the lawn terrain with environmental information including the size of the lawn, obstacle position and any restricted area. This virtual model can be generated by navigating the autonomous vehicle 100 about an operation area as well as by navigating with respect to boundaries that are set by markers that are placed within the operation area that indicates an obstacle or a restricted area (no go zone). These markers may be entered via the entry of co-ordinates of restricted areas into the system for processing by the navigation module 300, or by the sensors on board the autonomous vehicle 100 which are arranged to communicate with a navigational transmitter such as a Bluetooth beacon transmitter or Ultra wideband emitter unit placed around the lawn or near a restricted area.

Preferable, the navigation module 300 may be arranged to communicate with the controller 202 so as to navigate the unit to perform specific grass manipulation steps at particular locations, including, for example, the cutting of specific words, characters or patterns on the grass. To perform such a function, the user may firstly provide such instructions to the controller 202 as to the words, characters or patterns that he or she desires to be cut into the grass, followed by the location on the lawn to which he or she wishes the patterns to be cut into. The user, may be able to provide these commands via a digital interface, such as one on a smartphone which would allow it to communicate with the autonomous vehicle 100, either through the base station or directly with the vehicle 100 itself.

Once this information is transmitted to the controller 202, the controller 202 will operate with the navigation module 300 to identify the location to which the cutting steps are to be performed as well as to determine a cutting path or strategy to cut the characters or patterns into the lawn. Once these are determined, the autonomous vehicle 100 is then navigated to the operating area where the controller 202 will begin to operate the vehicle 100 and the mower blades to cut the grass. If necessary, a height adjustment unit may be activated to adjust the height of the vehicle 100 or vertical position of the blade so as to cut the grass to a certain length. Accordingly, when the controller 202 is controlling the height adjustment unit, the propulsion unit 204, with the assistance of the navigation module 300 and the mower blades, specific characters, words, patterns can be cut into the grass and thus allowing a user to draw specific patterns or words on their lawn.

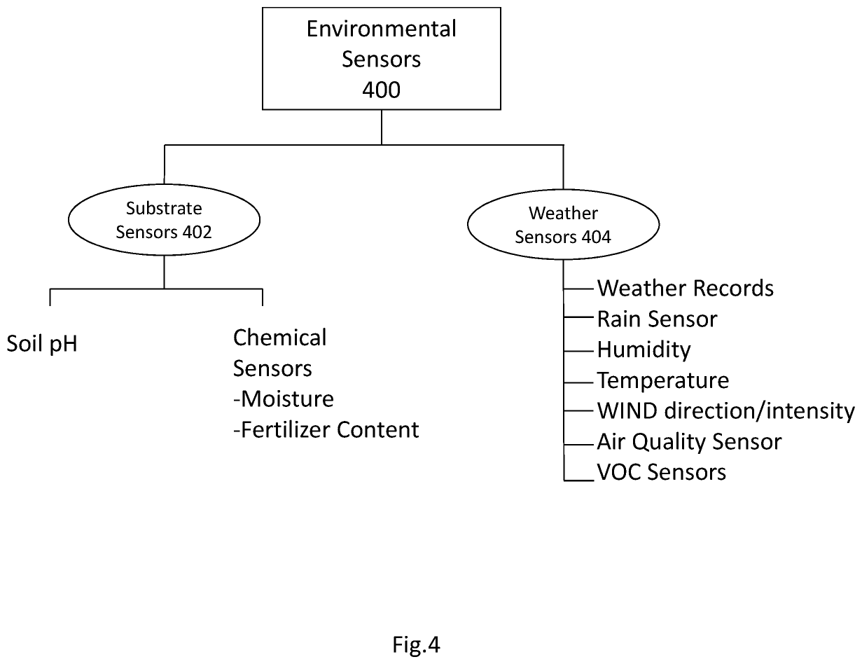

With reference to FIG. 4, there is illustrated a block diagram of the environmental sensors 400. In this embodiment, the environmental sensors 400 are arranged to detect and sense the conditions of the surrounding environment and the substrate conditions associated with the health of the grass growing within the operation area. These environmental sensors 400 may be deployed on the autonomous vehicle 100 itself and may use mechanical devices, such as mechanical arms, to probe certain sensors into the operating surface so as to obtain the environmental information.

In one example embodiment, the environmental sensors 400 include, without limitations:
Soil condition sensors 402, arranged to detect and measure soil pH, moisture levels of the soil or chemical composition of the soil for determining fertilizer levels or other chemical imbalances or toxicity;
Weather condition sensors 404, including humidity, temperature, wind direction and intensity, air quality sensors, volatile organic compound sensors;
Colour sensors or other optical sensors arranged to detect the colour of the grass or the colour range of the foliage to determine the health of the lawn.

Examples of these sensors may be integrated into the autonomous vehicle 100 so as to determine various environmental information when the vehicle 100 is operating. Rain sensors or moisture sensors, as well as weather conditions or air quality sensors may be placed on the vehicle 100 itself and thus the vehicle 100 is able to obtain various environmental information as it navigates about the operating area. This information may then be transmitted to an external computing device, such as a server or to a user's smart phone for processing and storage. In turn, this information may be used by the controller 202 to determine an operation plan for the grass maintenance system 200, including the frequency of mowing, fertilizing, watering or seeding to maintain the lawn as best possible.

In some examples, the soil condition sensors 402 may be placed on a wheel 104 or mechanical arm arranged to contact the ground surface when the autonomous vehicle 100 is in operation. As these sensors 402 may need to make contact or be in close proximity with the ground surface in order to obtain accurate condition information from the soil, the sensors 402 may be placed on a wheel 104 of the vehicle 100, either one of the main wheels or as a peripheral wheel that is implemented onto the autonomous vehicle 100. Where the sensor 402 requires probing within the substrate, such as moisture sensors, a mechanical arm may be implemented on the autonomous vehicle 100 to probe the sensor 402 into the soil by mechanical or pneumatic force.

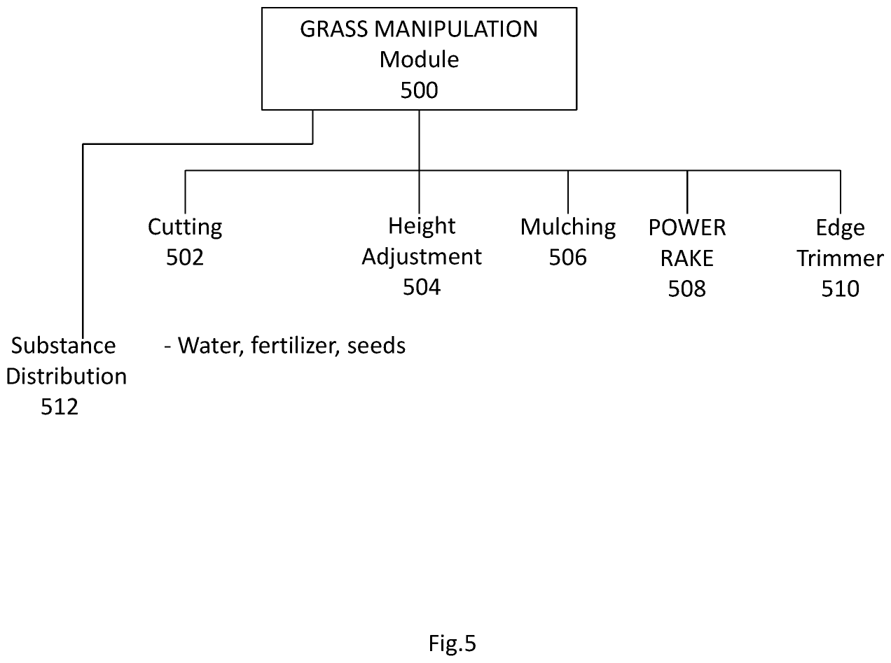

With reference to FIG. 5, there is illustrated a block diagram of an example embodiment of various grass manipulation modules 500, each arranged to manipulate the grass for the purposes of maintaining the grass within the operation area. These manipulation modules 500 may be controlled by the controller 202 when the autonomous vehicle 100 is in operation. The controller 202 may choose which of the manipulation modules 500 to operate as well as the frequency and location of their operation within an operation area. These decisions as made by the controller 202 can be part of a pre-determined operation plan as determined by the user's input and various environmental information that are detected for the operation area.

As illustrated, the system may have one or a plurality of grass manipulation modules 500 depending on the implementation as desired by an end user or manufacturer. These grass manipulation modules 500 may be arranged to manipulate the grass and may include, without limitations:
Cutting of the grass (mowing) 502. This may, for example, be a module having a blade unit that is arranged to cut or mow the grass to a desired length;
Trimming or edge trimming of the grass 510. This may for example, be a cutting unit that is arranged to cut the grass around objects or in gaps that are difficult to access. Examples may be a line trimmer unit or a edger blade arrangement;
Height adjustment mechanism 504 to adjust the height of the blade unit or trimmer;
Substance/liquid distribution 512 to the grass surface;
Collection of debris, vegetation, rubbish or animal faecal matter;
Mulching of grass debris 506; and
Raking of the grass surface 508.

Each of these modules may be arranged to be controlled by the controller 202 and operated by the controller 202 as based on the logical decisions of the controller 202 operating a program or software that has been implemented to perform autonomous lawn maintenance as based on a user desired requirement. Depending on the desired function of the autonomous vehicle 100, the controller 202 may operate one or more of these modules on the lawn at a particular time or location of the autonomous vehicle 100 in a particular operation area.

In some embodiments, these grass manipulation modules 500 may be implemented so as to be modularly installed onto the autonomous vehicle 100 and thus allowing certain modules to be installed whilst other modules are uninstalled. Preferably, the autonomous vehicle 100 can return to its base station to have one or more grass manipulation modules 500 removed and installed as necessary, with the controller 202 being arranged to communicate with the base station 212 as to which modules 500 are to be removed or installed based on what tasks the controller 202 intends to perform.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A grass maintenance system comprising:
an autonomous vehicle arranged to operate autonomously to manipulate a grass surface, wherein the vehicle includes:
one or more environmental sensors arranged to detect environmental conditions associated with the grass surface; and
one or more grass manipulation modules arranged to manipulate the grass surface.

2. A grass maintenance system in accordance with claim 1, wherein the autonomous vehicle further includes a control module arranged to obtain environmental conditions from the one or more environmental sensors for controlling the one or more grass manipulation modules to manipulate the grass surface.

3. A grass maintenance system in accordance with claim 2, wherein the control module includes a navigational module arranged to navigate the autonomous vehicle during its operation.

4. A grass maintenance system in accordance with claim 3, wherein the navigational module includes a positioning system arranged to determine a location of the autonomous vehicle during its operation.

5. A grass maintenance system in accordance with claim 4, wherein the positioning system uses a wireless signal to determine the location of the autonomous vehicle.

6. A grass maintenance system in accordance with claim 5, wherein the wireless signal is an Ultra Wideband signal.

7. A grass maintenance system in accordance with claim 1, wherein the environmental conditions associated includes one or more of temperature, humidity, wind intensity, wind direction, air quality, VOC levels, rain intensity.

8. A grass maintenance system in accordance with claim 1, wherein the environmental conditions further include substrate conditions.

9. A grass maintenance system in accordance with claim 8, wherein the substrate conditions include soil pH, soil chemistry, soil moisture or any one or combination thereof.

10. A grass maintenance system in accordance with claim 1, wherein the one or more grass manipulation modules is arranged to perform one or more of the following manipulation steps, including, mowing, cutting, trimming, edge trimming, raking, mulching.

11. A grass maintenance system in accordance with claim 10, wherein the one or more grass manipulation modules are further arranged to perform one or more of the following manipulation steps, including watering, fertilizing, seeding.

12. A grass maintenance system in accordance with claim 1, wherein the one or more grass manipulation modules include a height adjustment system arranged to adjust the height of a cutting blade so as to mow, cut or trim the grass to a certain length.

13. A grass maintenance system in accordance with claim 1, wherein the one or more environmental sensors are arranged to detect environmental condition about the grass surface, and to record the detected environmental condition detected with an associated position.

14. A grass maintenance system in accordance with claim 2, wherein the control module is arranged to determine an operation plan as based on the environmental conditions detected by the one or more environmental sensors.

15. A grass maintenance system in accordance with claim 14, wherein the operation plan is performed by the control module to manipulate the grass surface.

16. A grass maintenance system in accordance with claim 2, wherein the control module is arranged to communicate with an external computing device.

17. A grass maintenance system in accordance with claim 16, wherein the control module is arranged to exchange grass related data with a lawn maintenance platform.

18. A grass maintenance system in accordance with claim 1, wherein the one or more grass manipulation modules may be removably installed on the vehicle.

19. A grass maintenance system in accordance with claim 18, wherein the one or more grass manipulation modules may be removably installed autonomously.

20. A grass maintenance system in accordance with claim 19, wherein the one or more grass manipulation modules may be removed or installed when the vehicle is in a base station.

21. A grass maintenance system in accordance with claim 3, wherein the navigation module uses an odometry system to measure the distance travelled by the vehicle.

22. A grass maintenance system in accordance with claim 21, wherein the navigation module further uses a inertia measurement unit (IMU) to measure the direction travelled by the vehicle.

23. A grass maintenance system in accordance with claim 22, wherein the distance and direction travelled by the vehicle as measured by the odometry system and IMU are combined and used by the position system to assist the position system to determine the position.
